(19) United States
(12) Patent Application Publication
(10) Pub. No.: US 2017/0346672 A1
(43) Pub. Date: Nov. 30, 2017

(54) INFORMATION PROCESSING METHOD AND ELECTRONIC DEVICE

(71) Applicant: Lenovo (Beijing) Co., Ltd., Beijing (CN)

(72) Inventors: Kai LI, Beijing (CN); Mingxiang CAI, Beijing (CN); Jiaming TAO, Beijing (CN); Jingbin ZHAO, Beijing (CN)

(21) Appl. No.: 15/607,926

(22) Filed: May 30, 2017

(30) Foreign Application Priority Data
May 30, 2016 (CN) 201610371233.1

(51) Int. Cl. H04L 29/08; G06F 17/30; H04N 21/431; H04N 21/235; H04N 19/46; H04N 21/4782

(52) U.S. Cl. CPC H04L 29/08108; G06F 17/30905; H04N 21/4312; H04N 19/46; H04N 21/4782; H04N 21/235

(57) ABSTRACT

A method for information processing and corresponding electronic devices are provided. The method includes displaying a webpage of a first webpage style corresponding to a target link on a first display, acquiring a display parameter of a second display after the second display is connected, and determining whether the second display is of the same type as the first display to display the webpage via the first webpage style based on the display parameter. After determining that the second display is not of the same type as the first display, the method further includes sending a link request including identification information corresponding to a display type of the second display to the server to instruct the server to provide the webpage of a second webpage style, which is different from the first webpage style. The method further includes the second display displaying the webpage via the second webpage style.

### CROSS-REFERENCES TO RELATED APPLICATIONS

This application claims priority of Chinese Patent Application No. 201610371233.1, tiled on May 30, 2016, the entire contests of which arc hereby incorporated by reference.

### FIELD OF THE INVENTION

The present disclosure generally relates to the field of electronic technology and, more particularly, relates to a method for information processing and an electronic device.

### BACKGROUND

With the development of electronic technology, the screen size and the resolution of display devices have gradually become diversified.

To ensure desired user experience when different display devices are used to browse webpages, in response to a same http request, every website may return webpages displayed in different modes corresponding to different devices. For example, when a user browses www.sina.com using a cellphone, the returned webpage may be displayed in a portrait mode. However, when a user browses www.sina.com using a desktop computer, the returned webpage may be displayed in a landscape mode.

Specifically, when a smart cellphone is used to browse webpages, in order to display the corresponding webpage contents to many people and also achieve the best display results, the cellphone is often connected to an external display device (such as a laptop computer, etc.) such that all of the webpage contents may be projected onto the external display device. Further, the external display device may then be used to continue browsing the webpage. However, when the external display device is a personal computer (PC) type device, a television (TV) type device, or a display device of any other appropriate type, the webpage contents may still be displayed in the portrait mode. Further, the webpage contents may be displayed based on the device type of the smart cell phone. Moreover, during an actual operation process, the webpage contents may be displayed by a PC type display device and a TV type display device using a same landscape mode. That is, different display devices may now display a same webpage by same display formats. When the display formats of the webpage contents, such as font type, font size, etc., are still the same for different display devices, user experience may not be satisfied for every display device.

As illustrated above, according to the present disclosure, when existing electronic devices are used to display webpage contents, the operation performance may often be poor, which may further cause undesired user experience.

The disclosed information processing method and first electronic device are directed to solve one or more problems set forth above and other problems.

### BRIEF SUMMARY OF THE DISCLOSURE

A first aspect of the present disclosure is a method for information processing. The method includes displaying a webpage of a first webpage style corresponding to a target link through a browser and on a first display of an electronic device, acquiring a display parameter of a second display after it is determined that the electronic device is connected to the second display, and determining whether the second display is of the same type as the first display to display the webpage via the first webpage style based on the display parameter of the second display. After determining that the second display is not of the same type as the first display to display the webpage via the first webpage style, the method further includes sending a link request including identification information corresponding to the display type of the second display to the server to instruct the server to provide the webpage of a second webpage style, which is different from the first webpage style. Moreover, the method includes the second display displaying the webpage via the second webpage style.

A second aspect of the present disclosure is an electronic device. The electronic device includes a first display and a processor connected to the first display. The processor displays a webpage of a first webpage style corresponding to a target link through a browser and on the first display, acquires a display parameter of a second display after it is determined that the electronic device is connected to the second display, and determines whether the second display is of the same type as the first display to display the webpage via the first webpage style based on the display parameter of the second display. After determining that the second display is not of the same type as the first display to display the webpage via the first webpage style, the processor sends a link request. Including identification information corresponding to the display type of the second display to the server to instruct the server to provide the webpage of a second webpage style, which is different from the first webpage style. Moreover, the processor of the electronic device displays the webpage on the second display via the second webpage style.

The third aspect of the present disclosure is an electronic device. The electronic device includes a first operation unit used to display a webpage of a first webpage style corresponding to a target link through a browser and on a first display of an electronic device, a first acquisition unit used to acquire a display parameter of a second display after it is determined that the electronic device is connected to the second display, a first determination unit used to determine whether the second display is of the same type as the first display to display the webpage via the first webpage style based on the display parameter, a first adjustment unit used to change first identification information corresponding to the first display to second identification information different from the first identification information and corresponding to the second display after determining that the second display is not of the same type as the first display to display the webpage via the first webpage style, and a first output unit used to send a link request including the second identification information to the server to instruct the server to provide the webpage of a second webpage style such that the electronic device displays the webpage on the second display via the second webpage style, which is different from the first webpage style.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of an information processing method consistent with the disclosed embodiments;

FIG. 2 illustrates a flow chart for Step S103 according to the information processing method illustrated in FIG. 1;

FIG. 3 illustrates a flow chart of steps performed after Step S105 of the information processing method illustrated in FIG. 1;

FIG. 4a illustrates the display of the webpage contents on a second display when a webpage displayed in a first webpage style is projected onto the second display by a first electronic device according to an information processing method consistent with various embodiments of the present disclosure;

FIG. 4b illustrates the display of the second webpage contents in a second display format on a second display according to an information processing method consistent with various embodiments of the present disclosure;

FIG. 5 illustrates a schematic structural diagram of a first electronic device consistent with disclosed embodiments;

FIG. 6 illustrates a schematic structural diagram of another first electronic device consistent with disclosed embodiments;

FIG. 7 illustrates a flow chart of an example of using an information processing method disclosed in the present disclosure to browse webpages; and

FIG. 8 illustrates a schematic diagram of an example of using an electronic device disclosed in the present disclosure to browse webpages.

### DETAILED DESCRIPTION

As existing electronic devices may demonstrate poor operation performance in displaying webpage contents, which may further lead to undesired user experience, the present disclosure provides an improved information processing method and a first electronic device corresponding to the information processing method to improve the display performance of the electronic device, and thus improve the operation performance of the electronic device.

According to the disclosed information processing method and the first electronic device, a browser may be set to run. Specifically, a webpage of a first webpage style corresponding to a target link may be displayed on a first display of the first electronic device through the browser. Further, when the first electronic device is connected to a second display, a display parameter of the second display may be acquired. In addition, based on the obtained display parameter, whether the second display is of a same display type as the first display to display the webpage via the first webpage style may be determined.

When it is determined that the second display is not of the same display type as the first display to display the webpage via the first webpage style, the present identification information of the target link may be adjusted from a first identification information to a second identification information which is different from the first identification information. Further, a link request including the second identification information corresponding to the display type of the second display may be sent to the server to instruct the server to provide the webpage of a second webpage style that is different from the first webpage style.

According to the disclosed information processing method and the first electronic device, by running a browser, a first display of the first electronic device may use the browser to display a webpage corresponding to the target link via a first webpage style. Further, when the first electronic device is connected to a second display, the display parameter of the second display may be acquired. Moreover, based on the obtained display parameter, whether the second display is of a same display type as the first display to display the webpage via the first webpage style may be determined.

When it is determined that the second display is not of the same display type as the first display to display the webpage via the first webpage style, the present identification information of the target link may be adjusted from a first identification information to a second identification information different from the first identification information. Further, a link request including the second identification information corresponding to the display type of the second display may be sent to the server to instruct the server to provide the webpage of a second webpage style that is different from the first webpage style.

That is, when the first electronic device is running a browser, based on the display parameter of a second display that is connected to the first display of the first electronic device, the external second display may be controlled to display the webpage through the browser via a webpage style corresponding to the display type of the second display. As such, the disclosed method and the first electronic device may demonstrate desired performance in displaying webpage contents. Moreover, while the display performance of the electronic device is improved, the operation performance of the electronic device may also be improved.

Reference will now he made in detail to exemplary embodiments of the invention, which are illustrated in the accompanying drawings. Wherever possible, the same reference numbers will be used throughout the drawings to refer to the same or like parts. The described embodiments are some but not all of the embodiments of the present invention. Based on the disclosed embodiments and without inventive efforts, persons of ordinary skill in the art may derive other embodiments consistent with the present disclosure, all of which are within the scope of the present invention.

According to the disclosed embodiments, the disclosed electronic device may include a personal computer (PC), a personal access device (PAD), a cellphone, a notebook computer, a tablet computer, a smartphone, or any other appropriate electronic device.

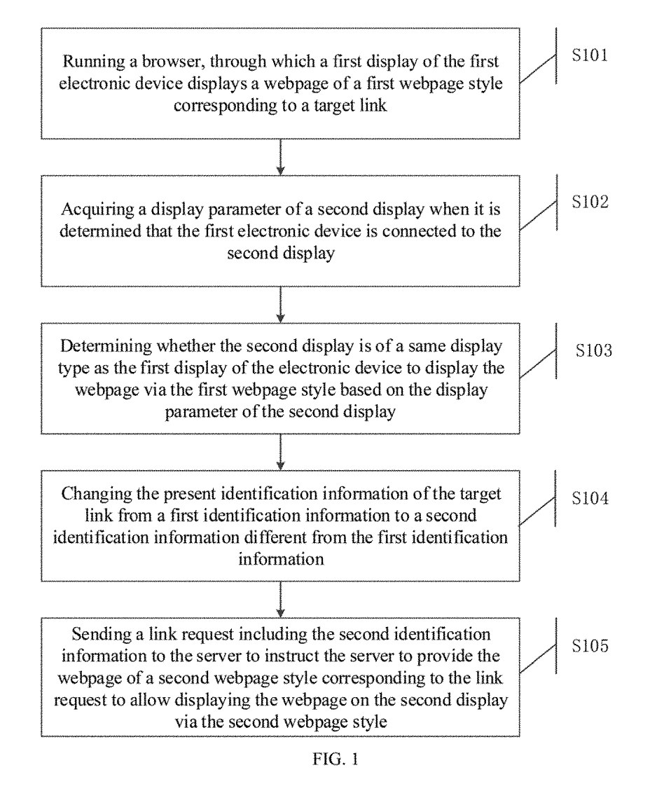

FIG. 1 illustrates a flow chart of an example of information processing methods consistent with the disclosed embodiments. Referring to FIG. 1, the information processing method may include the following steps.

Step S101: Running a browser. Specifically, a webpage of a first webpage style corresponding to a target link may be displayed on a first display of a first electronic device through the browser.

Step S102: Acquiring a display parameter of a second display when the first electronic device is connected to the second display.

Step S103: Determining whether the second display is of a same display type as the first display to display the webpage via the first webpage style based on the obtained display parameter.

Step S104: Changing the present identification information of the target link from a first identification information to a second identification information different from the first identification information when it is determined that the second display is not of the same display type as the first display to display the webpage via the first webpage style.

Step S105: Sending a link request including the second identification information to the server to instruct the server to provide the webpage of a second webpage style such that the second display may display the webpage via the second webpage style, which is different from the first webpage style.

During an actual implementation process, the specific execution of Steps S101-S105 may be as following.

First, it may be determined whether the first electronic device is running a browser. That is, whether the first electronic device is running an application program to browse webpages may be determined. In addition, the first electronic device may obtain a webpage of a first webpage style based on a link address that the user inputted into the browser. That is, the webpage of the first webpage style obtained by the first electronic device may be different when the link address is changed. After a target link is determined, the first display of the first electronic device may display the webpage corresponding to the target link via the first webpage style through the browser.

For example, the browser may be Microsoft Internet Explorer or Edge, Google Chrome, Apple Safari, Tencent QQ Browser, Baidu Mobile Browser, Sogou Mobile Browser, etc. The target link may be https://www.baidu.com, https://www.sina.com.cn, https://www.sohu.com, etc. Further, when the first electronic device is connected to the second display, a display parameter of the second display may be acquired.

Specifically, the second display may be connected with the first electronic device using a wired method or a wireless method. The second display may continue to display the webpage contents displayed on the first display before the connection is made. Therefore, the first display and the second display may share the display contents. As such, it may be convenient for the user to view the webpage contents using the second display.

Moreover, the second display may be a display device, or a display of a second electronic device different from the first electronic device. For example, when the first electronic device is a smart cellphone, the second electronic device may be a notebook computer, and accordingly, the second display may be the display screen of the notebook computer. In another example, when the first electronic device is a smart cellphone, the second display may also be an independent display screen, such as a liquid crystal display screen, etc.

Further, whether the second display is of a same display type as the first display to display the webpage via the first webpage style may be determined based on the obtained display parameter. That is, based on the obtained display parameter, the first electronic device may farther determine which webpage style may be adopted by the second display to display the webpage. For example, the second display may display the webpage via a webpage style corresponding to a portrait display mode.

During an actual implementation process, in order to ensure that the second display demonstrates the desired display effect in displaying the webpage, the second display may display the webpage via a second webpage style different from the first webpage style via which the first display displays the webpage. Moreover, when the second display displays the webpage via the second webpage style, the user may have desired visual experience. Further, when it is determined that the second display is currently displaying the webpage via an undesired webpage style, the first electronic device may adjust the present identification information of the target link from the first identification information to the second identification information different from the first identification information.

Further, a link request including the second identification information may be sent to the server to instruct the server to provide the webpage of the second webpage style such that the webpage may be displayed on the second display via the second webpage style different from the first webpage style. During an actual implementation process, different websites may return different webpage styles in response to a same http request but sent from different devices. For example, a web site may determine which type of device the request is sent out based on a user-agent (UA) on the http header when the http request (i.e. the link request) is sent out. Then, depending on the type of device, a specific webpage style may be returned. That is, the returned webpage style may correspond to the type of device. As such, while it is ensured that the second display demonstrates the desired display effect, the operation performance of the first electronic device may also be effectively improved.

According to the disclosed embodiments, Step S102 is to obtain the display parameter of the second display after it is determined that the first electronic device is connected to the second display. Specifically, Step S102 may include obtaining a second screen resolution and a second screen pixel density of the second display. For example, the second screen resolution of the second display may be 1280×720 and the pixel density of the second screen may be 320 pixels per inch (PPI).

Further, according to the disclosed embodiments, Step 103 may be performed. That is, whether the second display is of the same display type as the first display to display the webpage via the first webpage style may be determined based on the obtained display parameter. FIG. 2 shows a flow chart of Step S103. Referring to FIG. 2, in order to more precisely determine whether the second display is of the same type as the first display to display the webpage via the first webpage style, Step S103 may further include the following steps.

Step S201: Determining a second aspect ratio of the second display based on the second screen resolution.

Step S202: Determining a second device type corresponding to the second display based on the second aspect ratio and the pixel density of the second screen.

Step S203: Determining whether the second display is of the same type as the first display to display the webpage via the first webpage style based on the second aspect ratio and the second device type.

During an actual implementation process, the execution of Steps S201-S203 may be as following.

First, a second aspect ratio of the second display may be determined based on the second screen resolution. For example, when the second screen resolution is 1280×720, the second aspect ratio of the second display may be 1280:720, which indicates that the display mode of the second display may be the landscape display mode. When the second screen resolution is 1080×1920, the second aspect ratio of the second display may be 1080:1920, which indicates the display mode of the second display may be the portrait display mode.

Further, based on the second aspect ratio and the pixel density of the second screen, a second device type of the second display may be determined. For example, when the display mode of the second display is the landscape display mode, the second display may be a PC type device, a TV type device, or a Tablet type device. During an actual implementation process, in order to more precisely determine the device type of the second display, the pixel density of the second screen may be obtained to further help determining the device type of the second display.

For example, when the pixel density of the second screen is 213 PPI, the device type of the second display may be a TV type. After the second device type is determined, whether the second display is of the same display type as the first display to display the webpage via the first webpage style may be determined. For example, when the first electronic device is a smart cellphone and the first display of the first electronic device displays the webpage via a first webpage style corresponding to the portrait display mode of Android devices, because the screen resolution of the second display is 1280×720 and the screen pixel density is 213 PPI, the second display may display the webpage via a webpage style corresponding to the landscape display mode of TV type devices. Further, it may be determined that the second display will display wehpages via the webpage style corresponding to the landscape display mode of TV type devices. Specifically, the landscape display mode of TV type devices may be different from the portrait display mode of Android devices, and accordingly, the first webpage style may be different from the second webpage style. As such, the second display may demonstrate the desired display effect for users.

In another example, the first electronic device is a smart cellphone and the first, display of the first electronic device displays the webpage via a first webpage style corresponding to the portrait display mode of mobile type devices. Further, the screen resolution of the second display is determined to be 1080×1920, while the screen pixel density is determined to be 640 PPI. Therefore, the second display may display the webpage via a webpage style corresponding to the portrait display mode of mobile type devices. Further, it may be determined that the second display will display webpages via the webpage style corresponding to the portrait display mode of mobile type devices. As such, the second display may demonstrate the desired display effect for users.

During an actual implementation process, the mobile type device may be an Android device or an Apple device, and in addition, the screen size and the parameter used to adjust the webpage styles may also be different for different devices. In order to ensure the second display demonstrating the desired display effect, various strategies that can be used to precisely determine the device type may be designed based on actual needs.

Further, Step S203 may be performed. That is, whether the second display is of the same display type as the first display to display the webpage via the first webpage may be determined based on the second aspect ratio and the second device type. Moreover, when it is determined that the second display is not of the same display type as the first display to display the webpage via the first webpage style, in order to ensure that the second display demonstrates the desired display effect for the contents to be displayed, the disclosed method may further include changing a first identification information to a second identification information. Specifically, the first identification information may include at least the first device type of the first electronic device and the corresponding browser type, while the second identification information may include at least the second device type of the second display and the corresponding browser type.

During an actual implementation process, the device type and the present browser are usually distinguished by a UA. For example, the UA may distinguish desktop devices, Apple devices, Android devices, etc. For example, a UA of an iPad may be Mozilla/5.0 (iPad; U; CPU OS 3_2_1 like Mac OS x; en-us) AppleWebK.it/531.21.10 (KHTML, like Gecko) Mobile/7B405. Specifically, in the UA, (IPad; U; CPU OS 3_2_1 like Mac OS x; en-us) may describe the Information of the system, while AppleWebKit/531.21.10 (KHTML, like Gecko) may describe the information of the browser.

In another example, a UA of a Windows PC may be Mozilla/5.0 (Windows; U; Windows NT 5.1: en-US) AppleWebKit/525.13 (KHTML, like Gecko) Chrome 0.2.149.29 Safari/525.13. Moreover, a UA of an Android device may be Mozilla/5.0 (Linux; U; Android 4.0.3; ko-kr; LG-L160L Build/IML74K) AppleWebkit/534.30 (KHTML, like Gecko) Version/4.0 Mobile Safari/534.30.

During an actual implementation process, when it is determined that the second display is not of the same display type as the first display, and in order to demonstrate the desired display effect, a webpage style-different from the first webpage style is required to display the webpage on the second display, the present UA of the first electronic device may be changed to a UA that matches the second electronic device. Further, based on actual needs, persons of ordinary skill in the art may adjust the identification information corresponding to the target link such that the second display demonstrates the desired display effect for the contents to be displayed.

Further, according to the disclosed methods. Step S105 may be performed. That is, a link request that includes the second identification information may be sent to the server to instruct the server to provide the webpage of a second webpage style such that the webpage may be displayed on the second display using the second webpage style.

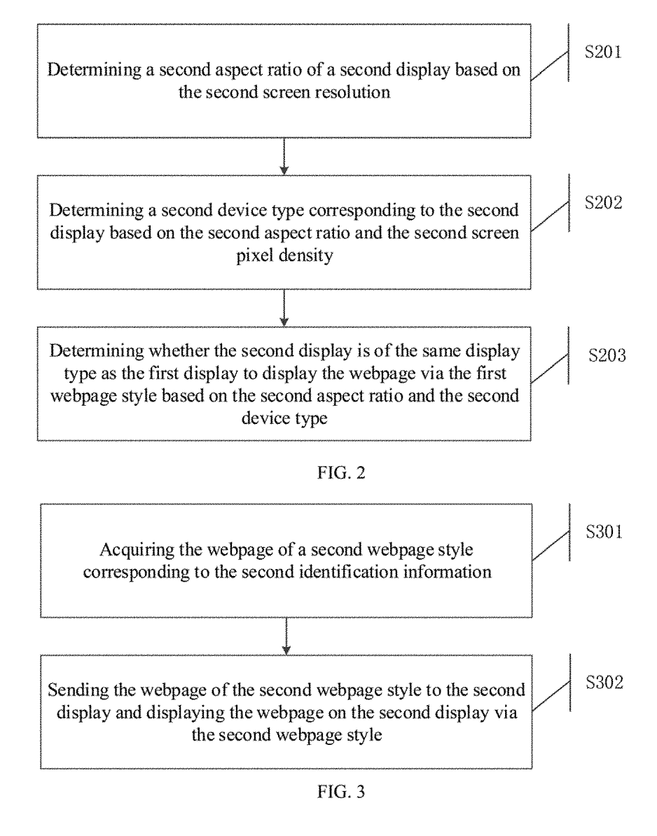

FIG. 3 shows a flow chart of the steps performed after performing Step S105. Referring to FIG. 3, after performing Step S105, the disclosed method may further include the following steps.

Step S301: Acquiring the webpage of a second webpage style corresponding to the second identification information based on the link request.

Step S302: Sending the second webpage to the second display such that the second display may display the webpage via the second webpage style.

During an actual implementation process, execution of Step 301 and Step 302 may be as following.

First, based on the link request, the webpage of a second webpage style corresponding to the second identification information may be obtained. Further, the webpage of the second webpage style may be sent to the second display, and thus the second display may display the webpage via the second webpage style. For example, the first identification information may be Mozilla/5.0 (Linux; U; Android 4.0.3; ko-kr; LG-L160L Build/IML74K) AppleWebkit/534.30 (KHTML, like Gecko) Version/4.0 Mobile Safari/534.30, while the second identification information may be Mozilla/5.0 (Windows; U; Windows NT 5.1; en-US) AppleWebKit/525.13 (KHTML, like Gecko) Chrome/0.2.149.29 Safari/525.13.

Further, when the first identification information is changed to the second identification information, the first electronic device may send a link request including the second identification information to the sever that corresponds to the target link. Moreover, the server may provide the webpage of a second webpage style. Further, the second webpage may be sent to the second display and the second display may then display the webpage via the second webpage style.

During an actual implementation process, the second display may display the webpage via the second webpage style which is different from the first webpage style. Specifically, the second display may use a second display format to display the contents included m the webpage. The second display format may be different from a first display format used to display the contents included in the webpage. Moreover, the webpage contents in the first display format and the webpage contents in the second display format may both correspond to the target link. That is, when the webpage of the first webpage style and the webpage of the second webpage style both come from a same target link, despite same contents included in the wehpages of the two webpage styles, different display formats may be used to display the webpage contents. Moreover, the display format may include font, font size, content layout, etc. Therefore, when a different webpage style is adopted, the webpage may be displayed using different fonts, different font sizes, different content layouts, etc.

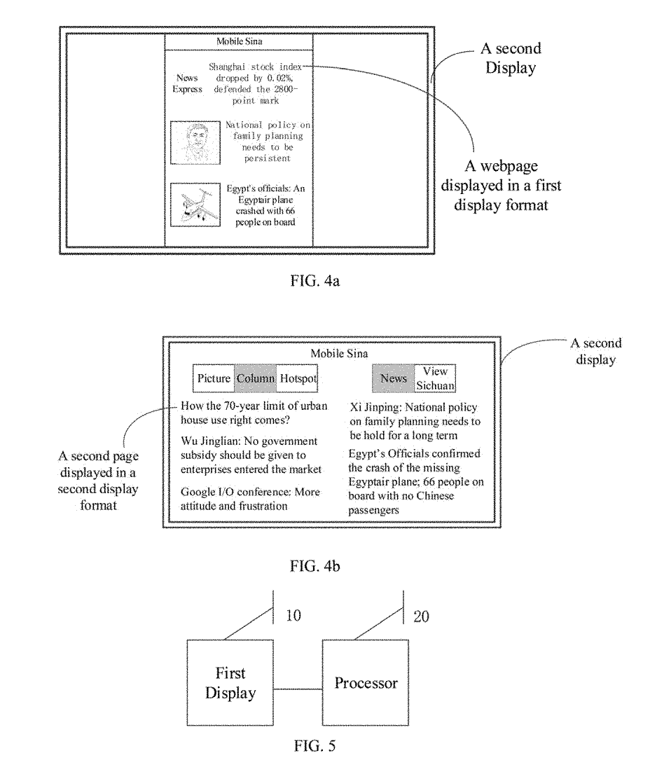

For example, the first electronic device may be a smart cellphone while the second display may be a display screen of a tablet FIG. 4a schematically illustrates the display of the webpage contents on the second display when the webpage displayed in the first display format is projected onto the second display by the first electronic device. Referring to FIG. 4a, the webpage contents may be displayed in the portrait display mode, while the font may be Arial font and the font size may be five.

FIG. 4b schematically illustrates, the display of the webpage contents on the second display using the second display format. Referring to FIG. 4b, when the second display format is used to display the webpage contents on the second display, the webpage contents may be displayed in the landscape display mode, while the font may be Arial font and the font size may be three.

The present disclosure further provides a first electronic device corresponding to the disclosed methods. FIG. 5 shows a schematic structural diagram of an example of the first electronic devices consistent with disclosed embodiments. Referring to FIG. 5, the first electronic device may include a first display 10 and a processor 20 connected to the first display 10.

The first display 10 may be a cathode ray tube (CRT) monitor, a liquid crystal display (LCD) device, a plasma display device, a light-emitting diode (LED) display device, an organic light-emitting diode (OLED) display device, or any other appropriate display device.

The processor 20 may include any appropriate type of graphic processing unit (GPU), general purpose microprocessor, digital signal processor (DSP) or microcontroller, and application specific integrated circuit (ASIC), etc., coupled with various memory modules, such as a random access memory (RAM) and a read-only memory (ROM), an input/output interface, a display unit, and a storage unit, etc. Processor 61 may execute sequences of computer program instructions to perform various information processing methods associated with the electronic device. The computer program instructions may be loaded into RAM for execution from ROM.

The processor 20 may be used to run a web browser. Moreover, through the browser, the first display 10 may display a webpage of a first webpage style corresponding to a target link. The processor 20 may also be used to acquire or receive a display parameter of a second display when the first electronic device is connected to the second display. Moreover, the processor 20 may then be used to determine whether the second display is of the same display type as the first display to display the webpage via the first webpage style based on the display parameter. When it is determined that the second display is not of the same display type as the first display and a webpage style different from the first webpage style is required to display the webpage on the second display, the processor 20 may further change the present identification information of the target link from a first identification information to a second identification information different from the first identification information. Further, the processor 20 may send out a link request including a second identification information to instruct the server to provide the webpage of a second webpage style corresponding to the target link such that the second display may display the webpage via the second webpage style, which is different from the first webpage style.

Moreover, according to the disclosed embodiments, the processor 20 may also be used to acquire a second screen resolution and a second screen pixel density of the second display.

Further, the processor 20 may be used to determine a second aspect ratio of the second display based on the second screen resolution, determine a second device type corresponding to the second display based on the second aspect ratio and the second screen pixel density. Moreover, based on the second aspect ratio and the second device type, the processor 20 may also be used to determine whether the second display is of the same display type as the first display, and thus farther determine whether the first webpage style should be used for the second display to display the webpage.

According to the disclosed method, after it is determined that the second display is not of the same display type as the first display and a webpage style different from the first webpage style is required to display the webpage on the second display, the processor 20 may be used to change the first identification information including at least the first device type of the first electronic device and the corresponding browser type to the second identification information including at least the second device type of the second display and the corresponding browser type.

Further, after sending the link request that includes the second identification information to the server, the processor 20 may also be used to obtain the webpage of a second webpage style corresponding to the second identification information based on the link request, and then send the webpage of the second webpage style to the second display such that the second display may display the webpage via the second webpage style.

According to the disclosed method, when the first display 10 uses a browser to display a webpage of a first webpage style corresponding to the target link, the contents of the webpage may be displayed using the first display format. In addition, when the second display displays a webpage of a second webpage style corresponding to the target link through the corresponding browser, the contents of the webpage may be displayed using the second display format which is different from the first display format. Moreover, the webpage contents in the first display format and the webpage contents in the second display format may both correspond to the target link.

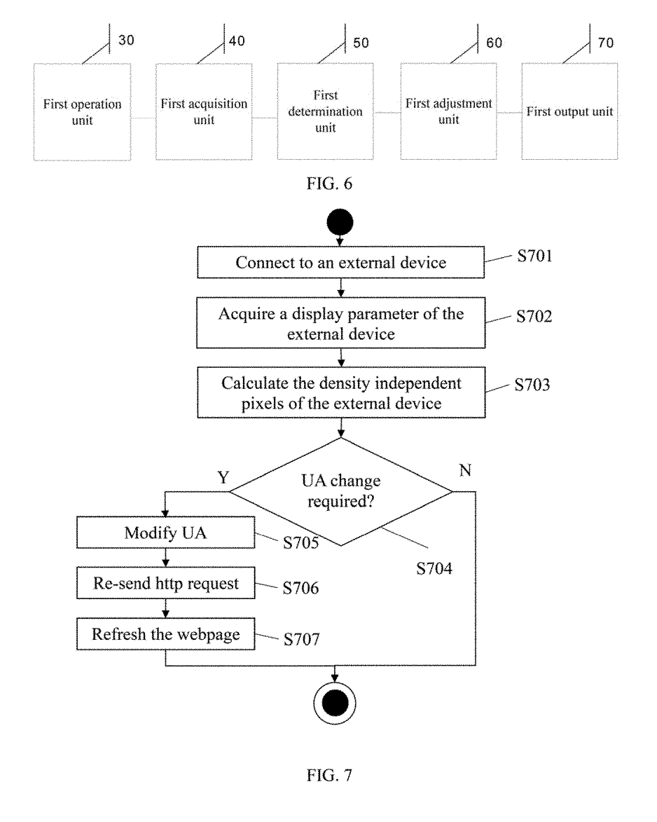

FIG. 6 shows a schematic structural diagram of another example of the first electronic devices consistent with disclosed embodiments. Referring to FIG. 6, the first electronic device may include a first operation unit 30, a first acquisition unit 40, a first determination unit 50, a first adjustment unit 60, and a first output unit 70.

The first operation unit 30 may be used to run a browser. Specifically, a first display of the first electronic device may use the browser to display a webpage of a first webpage style corresponding to the target link. The first acquisition unit 40 may be used to obtain a display parameter of a second display when it is determined that the first electronic device is connected to the second display. The first determination unit 50 may be used to determine whether the second display is of the same display type as the first display to display the webpage via the first webpage style based on the display parameter. The first adjustment unit 60 may be used to change the present identification information of the target link from a first identification information to a second identification information which is different from the first identification information. The first output unit 70 may be used to send a link request including the second identification information to the server to instruct the server to provide the webpage of a second webpage style such that the second display may display the webpage via the second webpage style.

According to the disclosed electronic device, the first acquisition unit 40 may be used to acquire a second screen resolution and a second screen pixel density of the second display.

Moreover, the first determination unit 50 may include a first determination module used to determine a second aspect ratio of the second display based on the second screen resolution, a second determination module used to determine a second device type corresponding to the second display based on the second aspect ratio and the second screen pixel density, and a third determination module used to determine whether the second display is of the same display type as the first display based on the second aspect ratio and the second device type.

According to the disclosed electronic device, the first electronic device may also include a second adjustment unit. When it is determined that the second display is not of the same display type as the first display and a webpage style different from the first webpage style is required to display the webpage on the second display, the second adjustment unit may change a first identification information including at least the first device type of the first electronic device and the corresponding browser type to a second identification information including at least the second device type of the second display and the corresponding browser type.

The first electronic device may also include a second acquisition unit. When the link request including the second identification information is sent to the server, the second acquisition unit may obtain the webpage of a second webpage style corresponding to the second identification information based on the link request.

The first electronic device may further include a second output unit. When the link request including the second identification information is sent to the server and the webpage of a second webpage style corresponding to the second identification information is obtained, the second output unit may send the webpage of the second webpage style to the second display such that the second display may display the webpage via the second webpage style.

Further, the disclosed information processing method may be adopted to browse websites. FIG. 7 illustrates a flow chart of an example of using an information processing method disclosed in the present disclosure to browse webpages.

Referring to FIG. 7, a first electronic device consistent with disclosed embodiments may be connected to an external device (S701). Prior to making the connection, a first display of the first electronic device may display a webpage of a first webpage style received from a website server as a response of a http request. Moreover, the external device may be a second display or another electronic device containing a second display. The second display is different from the first display of the electronic device.

Further, the display parameter of the external device may be acquired (S702). For example, a second screen resolution and a second screen pixel density of the external device may be acquired. Based on the obtained display parameter of the external device, the density independent pixels (DPI) of the long edge and the short edge of the external device may be calculated, respectively (S703).

Moreover, based on the DPI of the short edge of the external device, it is then determined whether the UA needs to be changed (S704). When it is determined that the UA needs to be revised (S704; Yes), after changing the UA (S705), the first electronic device may re-send the http request with the revised UA to the server (S706). That is, the link request sent to the server may now include a second identification information different from the original first Identification information. When it is determined that the UA does not need to be revised (S704; No), the process may complete.

Further, after resending the link request, the webpage of a second webpage style corresponding to the second identification information may be received from the server as a response of the re-sent http request, and then the webpage of the second webpage style may be sent to the external device such that the second display may display the webpage via the second webpage style, which is different from the first webpage style (S707). Specifically, the webpage of the second webpage style may be different from the webpage of the first webpage style displayed on the first display of the first electronic device.

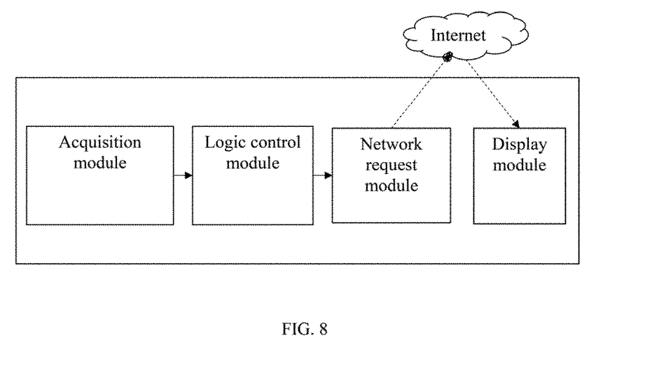

FIG. 8 illustrates a schematic diagram of an example of using an electronic device disclosed in the present disclosure to browse webpages. Referring to FIG. 8, the disclosed information processing method may be realized through the following four modules.

An acquisition module may be used to acquire the parameter of an external device. For example, the screen resolution and the screen pixel density of the external device may be obtained through the acquisition module. The external device may be a second display or another electronic device containing a second display.

A logic control module may be used to calculate the DPI of the long edge and the short edge of the external device, respectively based on the screen resolution and screen pixel density. The logic control module may further determine whether the UA needs to be revised based on the DPI of the short edge of the external device.

A network module may revise the UA and re-send the http request with the revised UA to the website server based on the output of the logic control module. Specifically, when the logic control module determines that the UA needs to be revised, the network module may first revise the UA, and then re-send the http request to the server with the revised UA.

A display module may update the display on the external device with the webpage of a second webpage style returned back from the server in response to the http request. Specifically, the second webpage style may be different from the first webpage style. As such, the external device may also demonstrate the desired display effect for users.

Accordingly, the disclosed method and first electronic device may realize one or multiple technical effects as followings.

By running a browser, a first display of the first electronic device may display a webpage of a first webpage style corresponding to the target link. Further, when it is determined that the first electronic device is connected to a second display, a display parameter of the second display may be obtained. Moreover, based on the display parameter, whether the second display is of the same display type as the first display and whether a webpage style different from the first webpage style is required to display the webpage on the second display may be determined.

When it is determined that the second display is not of the same display type as the first display and a webpage style different from the first webpage style is required to display the webpage on the second display, the present identification information of the target link may be changed from a first identification information to a second identification information which is different from the first identification information. Further, a link request including the second identification information may then be sent to the server to instruct the server to provide the webpage of a second webpage style such that the second display may display the webpage via the second webpage style, which is different from the first webpage style.

That is, when the first electronic device is running a browser and a second display is connected to a first display of the first electronic device, based on the display parameter of the second display, the first electronic device may control the second display to adjust the display format for the webpages to he displayed through the browser. As such, the poor operation performance of existing electronic de vices may be avoided. Therefore, the display performance of the electronic device may be improved, and in the meantime, the operation performance of the electronic device may also be improved.

Moreover, according to the disclosed method and electronic device, the second aspect ratio of the second display may be determined based on the second screen resolution. Then, the second device type corresponding to the second display may be determined based on the second aspect ratio and the second screen pixel density. Further, whether the second display is of the same display type as the first display to display the webpage via the first webpage style may then be determined based on the second aspect ratio and the second device type. That is, the first electronic device may be able to determine the desired webpage style for the external display device to display webpages based on the obtained screen resolution and the screen pixel density of the external display device, and thus improve the operation performance of the first electronic device.

Moreover, embodiments consistent with the present disclosure may provide a variety of methods, systems, and computer program products. That is, various embodiments consistent with the present disclosure may be in the forms of methods, systems, and computer program products. Therefore, embodiments consistent with the present disclosure may be all-hardware based, all-software based, or combinations of both hardware and software. In addition, embodiments consistent with the present disclosure may also be computer program products operated on computer-based storage media that include computer-based programming code. The computer-based storage media may include magnetic storage disk, compact disk read-only memory (CD-ROM), optical memory, and other appropriate storage media.

The present disclosure is described based on the flow chart and/or the block diagram of methods, devices (systems), and computer program products consistent with various embodiments of the present disclosure. The present disclosure may include not only individual procedure and/or individual block of the flow chart and/or the block diagram but also the combinations of the procedures and/or the blocks of the flow chart and/or the block diagram that can be realized by computer program commands. These computer program commands may be sent to a processor of a general-purpose computer, a special-purpose computer, an embedded processing system, or any other programmable data processing equipment to generate a machine. As such, a device used to realize specified functions of one or more procedures in the flow chart and/or specified functions of one or more blocks in the diagram may be generated by the commands operated by the computer or other programmable data processing equipment.

These computer program commands may also be stored in a computer-readable memory that can guide a computer or other programmable data processing equipment to work in a specific manner so that the commands stored in the computer-readable memory may generate a machine including an instruction device. The instruction device may be used to realize specified functions of one or more procedures in the flow chart and/or specified functions of one or more blocks in the diagram.

In addition, these computer program commands may also be loaded into a computer or other programmable data processing equipment so that the computer or the programmable equipment may execute a series of operation procedures to generate a computer-based implementation process. As such, commands executed on the computer or other programmable data processing equipment may provide execution procedures to realize specified functions of one or more procedures in the flow chart and/or specified functions of one or more blocks in the diagram.

For example, computer program commands corresponding to a charging method that is consistent with various embodiments of the present disclosure may be stored in storage media such as optical disc, hard disc, U disc, etc. Further, using an electronic device to read out or execute the computer program commands stored in the storage media and corresponding to a charging method may include the following steps.

First, a browser may be set to run. Specifically, a first display of the first electronic device may display a webpage of a first webpage style corresponding to the target link through the browser. Further, when it is determined that the first electronic device is connected to a second display, a display parameter of the second display may be acquired or received. Based on the obtained display parameter, whether the second display is of the same display type as the first display and whether a webpage style different from the first webpage style is required to display the webpage on the second display may be determined. When it is determined that the second display is not the same display type as the first display and a webpage style different from the first webpage style is required to display the webpage on the second display, the present identification information may be changed from a first identification information to a second identification information which is different from the first identification. Further, a link request including the second identification information may be sent to the server to instruct the server to provide the webpage of a second webpage style such that the second display may display the webpage via the second webpage style.

Optionally, executing the computer program commands that correspond to acquiring the display parameter of the second display may include obtaining a second screen resolution and a second screen pixel density of the second display.

Optionally, executing the computer program commands that correspond to determining whether the second display is of the same display type as the first display based on the display parameter may further include determining a second aspect ratio of the second display based on the second screen resolution, determining a second device type corresponding to the second display based on the second aspect ratio and the second screen pixel density, and then determining whether the second display is of the same display type as the first display to display the webpage via the first webpage style based on the second aspect ratio and the second device type.

Optionally, after determining whether the second display is of the same display type as the first display and whether a webpage style different from the first webpage style is required to display the webpage on the second display, executing the computer program commands may further include changing a first identification information including at least the first device type of the first electronic device and the corresponding browser type to a second identification information including at least the second device type of the second display and the corresponding browser type when it is determined that a second webpage style different from the first webpage style is required to display the webpage on the second display. Specifically, the second identification information may be different from the first identification information.

Optionally, after the link request including the second identification information is sent to the server, executing the computer program commands may further include obtaining the webpage of a second webpage style that corresponds to the second identification information and then sending the webpage of the second webpage style to the second display such that the second display may display the webpage via the second webpage style.

Optionally, executing the computer program commands corresponding to using a second webpage style which is different from the first webpage style to display the webpage including that the second display uses a second display format to display the webpage contents included in the webpage. Specifically, the second display format may be different from the first display format used to display the webpage contents of the webpage. In addition, the contents of the first webpage style and the contents of the second webpage style may both correspond to the target link.

Compared to existing methods and electronic devices, the disclosed method and first electronic device may realize one or multiple technical effects.

According to the disclosed method and electronic device, through running a browser, a first display of the first electronic device may display a webpage of a first webpage style corresponding to the target link. Further, when it is determined that the first electronic device is connected to a second display, a display parameter of the second display may be obtained. Moreover, based on the display parameter, whether the second display is of the same display type as the first display to display the webpage via the first webpage style may be determined.

When it is determined that the second display is not of the same display type as the first display and a webpage style different from the first webpage style is required to display the webpage on the second display, the present identification information of the target link may be changed from a first identification information to a second identification information which is different from the first identification information. A link request including the second identification information may then be sent to the server to instruct the server to provide the webpage of a second webpage style such that the second display may display the webpage via the second webpage style, which is different from the first webpage style.

That is, during the first electronic device running a browser, the first electronic device may control the second display to adjust the display format for the webpage to be displayed through the browser based on the display parameter of the second display that is connected to the first display of the first electronic device. As such, the poor operation performance of existing electronic devices may be avoided. Therefore, the display performance of the electronic device may be improved, and in the meantime, the operation performance of the electronic device may also be improved.

Further, in the present disclosure, relational terms such as first, second, and the like, may be used solely to distinguish one entity or action from another entity or action without necessarily requiring or implying any actual such relationship or order between such entities or actions, The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the present specification are described in a progressive manner, in which each embodiment focusing on aspects different from other embodiments, and the same and similar parts of each embodiment may be referred to each other. Because the disclosed devices correspond to the disclosed methods, the description of the disclosed devices and the description of the disclosed methods may be read in combination or in separation.

The description of the disclosed embodiments is provided to illustrate the present invention to those skilled in the art. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for information processing, comprising:
displaying a webpage of a first webpage style through a browser and on a first display of an electronic device;
acquiring a display parameter of a second display after it is determined that the electronic device is connected to the second display;
determining from the acquired display parameter whether the second display is of a same display type as the first display to display the webpage via the first webpage style;
after determining that the second display is not of the same display type as the first display to display the webpage via the first webpage style, sending a link request including identification information corresponding to a display type of the second display to a server to instruct the server to provide the webpage of a second webpage style that is different from the first webpage style; and
the second display displaying the webpage via the second webpage style.

2. The method for information processing according to claim 1, wherein the step of acquiring the display parameter of the second display further includes:
acquiring a screen resolution and/or a screen pixel density of the second display.

3. The method for information processing according to claim 2, wherein the step of determining from the acquired display parameter whether the second display is of the same display type as the first display to display the webpage via the first webpage style further includes:
determining an aspect ratio of the second display based on the acquired screen resolution;
determining a device type of the second display based on the aspect ratio of the second display; and
determining based on the device type of the second display whether the second display is to optimally suitable to display the webpage via the first webpage style.

4. The method for information processing according to claim 3, after determining that the second display is not of the same display type as the first display to display the webpage via the first webpage style, the method further includes the step of:
changing first identification information corresponding to the first display to second identification information corresponding to the second display, wherein;
the first identification information includes at least a first device type of the electronic device and a corresponding browser type; and
the second identification information includes at least the second device type of the second display and a corresponding browser type.

5. The method for information processing according to claim 1, wherein after sending the link request including the identification information corresponding to the display type of the second display to the server, the method further includes the steps of:
acquiring the webpage of the second webpage style corresponding to the second identification information based on the link request; and
sending the webpage of the second webpage style to the second display such that the second display displays the webpage via the second webpage style.

6. The method for information processing according to claim 1, wherein the step of the second display displaying the webpage via the second webpage style further includes:
the second display using a display format to display webpage contents included in the webpage, wherein,
the display format is different from a corresponding display format that is used to display the webpage contents included in the webpage on the first display.

7. An electronic device, comprising:
a first display; and
a processor connected to the first display, wherein the processor
displays a webpage of a first webpage style corresponding to a target link through a browser and on the first display;
acquires a display parameter of a second display after it is determined that the electronic device is connected to the second display;
determines whether the second display is of a same display type as the first display to display the webpage via the first webpage style based on the display parameter of the second display;
after determining that the second display is not of the same display type as the first display to display the webpage via the first webpage style, sends a link request including identification information corresponding to a display type of the second display to a server to instruct the server to provide the webpage of a second webpage style, which is different from the first webpage style; and
displays the webpage of the second webpage style on the second display.

8. The electronic device according to claim 7, wherein the processor further acquires, a screen resolution and/or a screen pixel density of the second display.

9. The electronic device according to claim 8, wherein the processor further
determines an aspect ratio of the second display based on the acquired screen resolution;
determines a device type of the second display based on the aspect ratio of the second display; and
determines based on the device type of the second display whether the second display is to optimally suitable to display the webpage via the first webpage style.

10. The electronic device according to claim 9, wherein after determining that the second display is not of the same display type as the first display to display the webpage via the first webpage style, the processor further
changes first identification information corresponding to the first display to second identification information corresponding to the second display, wherein:
the first identification information includes at least a first device type of the electronic device and a corresponding browser type; and
the second identification information includes at least the second device type of the second display and a corresponding browser type.

11. The electronic device according to claim 7, wherein after sending the link request including the identification information corresponding to the display type of the second display to the server, the processor further:
acquires the webpage of the second webpage style corresponding to the second identification information based on the link request; and
sends the webpage of the second webpage style to the second display such that the second display displays the webpage via the second webpage style.

12. The electronic device according to claim 7, wherein:
the second display uses a display format to display the webpage contents included in the webpage, wherein,
the display format is different from a corresponding display format that is used to display the webpage contents included in the webpage on the first display.

13. An electronic device, comprising:
a first operation unit, used to display a webpage of a first webpage style corresponding to a target link through a browser and on a first display of an electronic device;
a first acquisition unit, used to acquire a display parameter of a second display after it is determined that the electronic device is connected to the second display;
a first determination unit, used to determine whether the second display is of the same display type as the first display to display the webpage via the first webpage style based on the display parameter;
a first adjustment unit, used to change first identification information corresponding to the first display to second identification information corresponding to the second display after determining that the second display is not of the same display type as the first display to display the webpage via the first webpage style; and
a first output unit, used to send a link request including the second identification information to a server to instruct the server to provide the webpage of a second webpage style such that the second display displays the webpage via the second webpage style that is different from the first webpage style.

14. The electronic device according to claim 13, wherein acquiring the display parameter of the second display using the first acquisition unit further includes:
acquiring a screen resolution and/or a screen pixel density of the second display using the first acquisition unit.

15. The electronic device according to claim 14, wherein the first determination unit further includes:
a first determination module used to determine an aspect ratio of the second display based on the acquired screen resolution;
a second determination module used to determine a device type of the second display based on the aspect ratio of the second display; and
a third determination module used to determine based on the device type of the second display whether the second display is to optimally suitable to display the webpage via the first webpage style.

16. The electronic device according to claim 13 further includes a second adjustment unit, wherein:
after determining that the second display is of the same display type as the first display to display the webpage via the first webpage style, the second adjustment unit changes the first identification information including at least the first device type of the electronic device and the corresponding browser type to the second identification information including at least tire second device type of the second display and the corresponding browser type.

17. The electronic device according to claim 13 further includes a second acquisition unit, wherein:
after sending the link request including the second identification information to the server, the second acquisition unit obtains the webpage of a second webpage style corresponding to the second identification information based on the link request.

18. The electronic device according to claim 17 further includes a second output unit, wherein:
after sending the link request including the second identification information to the server and receiving the webpage of the second webpage style corresponding to the second identification information, the second output unit sends the webpage of the second webpage style to the second display such that the second display displays the webpage via the second webpage style.
